(19) United States
(12) Patent Application Publication
(10) Pub. No.: US 2026/0069485 A1
(43) Pub. Date: Mar. 12, 2026

(54) ACTUATOR AND MOTION ASSISTIVE DEVICE COMPRISING SAME

(71) Applicant: Samsung Electronics Co., Ltd., Suwon-si (KR)

(72) Inventors: Kichul WOO, Suwon-si (KR); Byounggi KWON, Suwon-si (KR); Hyunmin OH, Suwon-si (KR); Ganggyun KIM, Suwon-si (KR); Junseok KIM, Suwon-si (KR)

(21) Appl. No.: 19/391,221

(22) Filed: Nov. 17, 2025

Related U.S. Application Data
(63) Continuation of application No. PCT/KR2024/006309, filed on May 10, 2024.

(30) Foreign Application Priority Data
May 18, 2023 (KR) 10-2023-0064619
Aug. 7, 2023 (KR) 10-2023-0102839

(51) Int. Cl. A61H 3/00; A61H 1/02; F16H 19/08; F16H 57/02

(52) U.S. Cl. CPC A61H 3/00; A61H 1/0244; F16H 19/08; A61H 2201/1215; A61H 2201/1621; A61H 2201/1642; F16H 57/02; F16H 2057/02034; F16H 2057/02073

(57) ABSTRACT

A motion assistive device is provided. The motion assistive device includes a waist frame to be worn on a user's waist, a waist belt connected to the waist frame and covers a portion of the user's waist, a force transfer frame that covers a portion of the user's thigh, a thigh belt connected to the force transfer frame and surrounds the user's thigh, an actuator connected to the waist frame and generates power, and a driving frame connected to the actuator and transfers the power to the force transfer frame, wherein the actuator includes a housing, a stator fixed to the housing, a rotor positioned inside the stator and rotatable relative to the stator, a reducer inserted into the rotor, having an input end connected to the rotor, and accommodates a lubricant, an outer washer attached to the reducer and guides movement of the lubricant discharged from the reducer, and an inner washer disposed between the outer washer and the reducer.

### CROSS-REFERENCE TO RELATED APPLICATION(S)

This application is a continuation application, claiming priority under 35 U.S. C. § 365(c), of an International application No. PCT/KR2024/006309, filed on May 10, 2024, which is based on and claims the benefit of a Korean patent application number 10-2023-0064619, filed on May 18, 2023, in the Korean Intellectual Property Office, and of a Korean patent application number 10-2023-0102839, filed on Aug. 7, 2023, in the Korean Intellectual Property Office, the disclosure of each of which is incorporated by reference herein in its entirety.

### BACKGROUND

### 1. Field

The disclosure relates to an actuator and a motion assistive device including the same.

### 2. Description of Related Art

In a rapidly aging society, a growing number of people are complaining of joint-related inconvenience and pain. Accordingly, there is a heightened interest in an assistive device for assisting the elderly or patients having joint problems. A motion assistive device may also be worn to increase muscular strength of a certain body part.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus for an actuator and a motion assistive device including the same.

Additional aspects will be set forth in part in the description which follows and, in part, will be apparent from the description, or may be learned by practice of the presented embodiments.

In accordance with an aspect of the disclosure, a motion assistive device is provided. The motion assistive device includes a waist frame worn on a user's waist, a waist belt connected to the waist frame and covers a portion of the user's waist, a force transfer frame that covers a portion of the user's thigh, a thigh belt connected to the force transfer frame and surrounds the user's thigh, an actuator connected to the waist frame and generates power, and a driving frame connected to the actuator and transfers the power to the force transfer frame, wherein the actuator includes a housing, a stator fixed to the housing, a rotor positioned inside the stator and rotatable relative to the stator, a reducer inserted inside the rotor, having an input terminal connected to the rotor, and accommodates a lubricant, an outer washer attached to the reducer and guides movement of the lubricant discharged from the reducer, and an inner washer disposed between the outer washer and the reducer.

In accordance with another aspect of the disclosure, an actuator is provided. The actuator includes a housing, a stator fixed to the housing, a rotor positioned inside the stator and rotatable relative to the stator, a first sun gear inserted inside the rotor, accommodates a lubricant, is fixed to the rotator, and rotates about a rotation axis of the rotator, a ring gear fixed to the housing and surrounds the first sun gear, a plurality of first planetary gears disposed between the first sun gear and the ring gear and engages with the first sun gear and the ring gear, a reducer including a first carrier connected to a central axis of each of the plurality of first planetary gears, an outer washer attached to the ring gear and guides movement of the lubricant discharged from the reducer, and an input terminal sealing member connected to the outer washer, and blocks the lubricant from moving into a space between the outer washer and the first sun gear.

In accordance with another aspect of the disclosure, a motion assistive device is provided. The motion assistive device includes a waist frame worn on a user's waist, a waist belt connected to the waist frame and covers a portion of the user's waist, a force transfer frame that covers a portion of the user's thigh, a thigh belt connected to the force transfer frame and surrounds the user's thigh, an actuator connected to the waist frame and generates power, and a driving frame connected to the actuator and transfers the power to the force transfer frame, wherein the actuator includes a housing, a stator fixed to the housing, a rotor positioned inside the stator and rotatable relative to the stator, a reducer inserted inside the rotor, having an input terminal connected to the rotor, and accommodates a lubricant, an outer washer attached to the reducer and guides movement of the lubricant discharged from the reducer, and a supporter that supports the reducer and is detachably connected to the housing, an input terminal sealing member connected to the outer washer, and blocks the lubricant from moving into a space between the outer washer and the reducer, and an output terminal bearing supported by the supporter and the reducer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a user wearing a motion assistive device according to an embodiment of the disclosure;

FIG. 2 is perspective view illustrating an actuator cover, an actuator, and driving frame according to an embodiment of the disclosure;

FIG. 3 is an exploded perspective view of an actuator according to an embodiment of the disclosure;

FIG. 4 is a cross-sectional view of an actuator according to an embodiment of the disclosure;

FIG. 5 is a partially enlarged view of an actuator according to an embodiment of the disclosure;

FIG. 6A is a cross-sectional view schematically illustrating a path through which a lubricant leaks from an input terminal of a reducer according to an embodiment of the disclosure;

FIG. 6B is a cross-sectional view schematically illustrating a path through which a lubricant leaks from an input terminal of a reducer according to an embodiment of the disclosure;

FIG. 7 is a cross-sectional view of an actuator according to an embodiment of the disclosure; and

FIG. 8 is a cross-sectional view of an actuator according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The same name may be used to describe an element included in the embodiments described above and an element having a common function. Unless otherwise mentioned, the descriptions on the embodiments may be applicable to the following embodiments and thus, duplicated descriptions will be omitted for conciseness.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

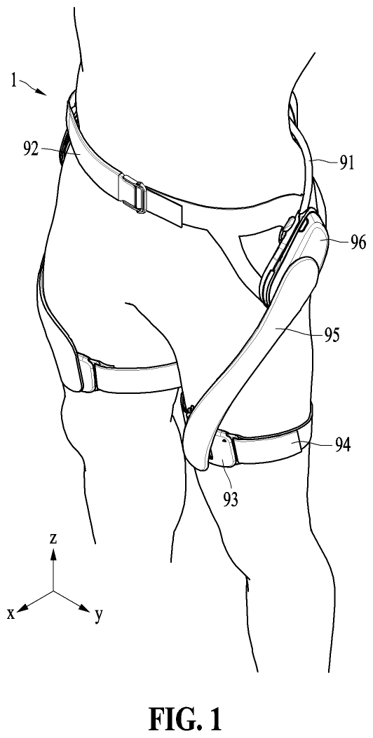

FIG. 1 is a perspective view illustrating a user wearing a motion assistive device according to an embodiment of the disclosure.

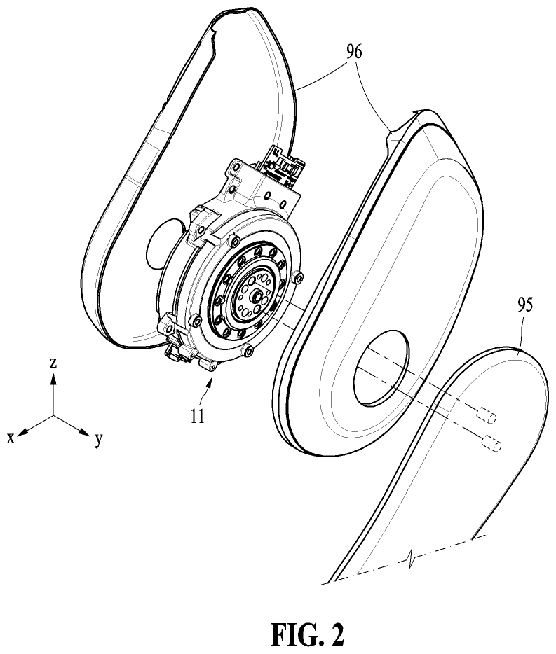

FIG. 2 is perspective view illustrating an actuator cover, an actuator, and driving frame according to an embodiment of the disclosure.

Referring to FIGS. 1 and 2, a motion assistive device 1, according to an embodiment of the disclosure, may be worn by a user to assist a motion of a user. The user may be a human, a robot, or the like but is not limited thereto. The motion assistive device 1 may assist a motion of some upper or lower body joints of the user. For example, the motion assistive device 1 may assist the motion of the lower body of the user by assisting at least one of a hip joint, a knee joint, and an ankle joint of the user. The motion assistive device 1 may include a waist frame 91, a waist belt 92, a force transfer frame 93, a thigh belt 94, an actuator 11, and a driving frame 95.

Here, the waist frame 91 and the waist belt 92 may form a waist wearing part. In addition, the force transfer frame 93 and the thigh belt 94 may form a thigh wearing part.

In an embodiment of the disclosure, the waist wearing part and the thigh wearing part may be disposed on opposite sides based on a body part of the user, and may be respectively worn on a proximal part and a distal part of the user. For example, the waist wearing part may surround a waist and/or a pelvis of the user and the thigh wearing part may surround a thigh, a knee, a calf, and/or a foot of the user.

In an embodiment of the disclosure, the waist frame 91 may be worn on the waist of the user. The waist here is a body part that connects the upper and lower body of the user. Based on a frontal plane, a front surface of the waist is positioned on the same plane as the abdomen, a rear surface of the waist is on the same plane as the back. One end and the other end of the waist belt 92 may be connected to one end and the other end of the waist frame 91, respectively, and may surround the waist of the user. For example, referring to FIG. 1, the waist frame 91 may surround the rear surface of the waist of the user, the waist belt 92 may surround the front surface of the waist of the user. For example, a buckle may be provided on the waist belt 92.

Meanwhile, unlike what is shown in the drawings herein, it is to be noted in advance that the waist frame 91 may surround the rear surface of the waist of the user, and the waist belt 92 may surround the front surface of the waist of the user.

In an embodiment of the disclosure, the force transfer frame 93 may cover the front side of the thigh of the user. The thigh belt 94 may be connected to the force transfer frame 93, and may surround the thigh of the user.

In an embodiment of the disclosure, the waist wearing part and the thigh wearing part may move relative to each other on a sagittal plane. For example, in the case of hip joint flexion or extension while the user wears the motion assistive device 1, the thigh wearing part may rotate relative to the waist wearing part on the sagittal plane.

In an embodiment of the disclosure, the waist wearing part and the thigh wearing part may move relative to each other on the frontal plane. For example, in the case of hip joint adduction or abduction while the user wears the motion assistive device 1, the thigh wearing part may rotate relative to the waist wearing part on the frontal plane.

In an embodiment of the disclosure, the driving frame 95 and the thigh wearing part may move relative to each other on a transverse plane. For example, when the user rotates the thigh while wearing the motion assistive device 1, the thigh wearing part may rotate together with the thigh of the user while being in close contact with the thigh. The thigh wearing part may rotate relative to the driving frame 95. In this structure, the wearability of the motion assistive device 1 may be improved.

In an embodiment of the disclosure, the actuator 11 may be connected to the waist frame 91 and may generate power. The actuator 11 may be provided within the actuator cover 96 so that the actuator 11 may be protected from external impact or entering of a foreign substance. The actuator 11 may include, for example, a motor and a reducer. The motor may include at least one of a brush motor, a brushless motor, and a stepping motor. The motor may include at least one of an induction motor and a synchronous motor. The reducer may include, for example, a gear train.

In an embodiment of the disclosure, the actuator 11 may be a hollow actuator 11 in which a motor and a reducer are not simply connected in series, but the reducer is accommodated in a groove formed inside the motor and shares a shaft with each other. In this structure, a width of the actuator 11 may be reduced. By reducing a height at which the actuator 11 protrudes from the user, a volume of the motion assistive device 1 may be reduced, and for example, the user may wear the motion assistive device 1 inside clothing.

In an embodiment of the disclosure, the driving frame 95 may transfer power generated by the actuator 11 to the force transfer frame 93. The driving frame 95 may be connected to the actuator 11, for example, through a pair of protrusions formed on the driving frame 95. For example, the driving frame 95 may assist the motion of the hip joint of the user. When an output terminal of the actuator 11 rotates in one direction, the driving frame 95 may receive power from the actuator 11 and assist flexion of the hip joint of the user. When the output terminal of the actuator 11 rotates in an opposite direction to the one direction, the driving frame 95 may receive power from the actuator 11 and assist extension of the hip joint of the user.

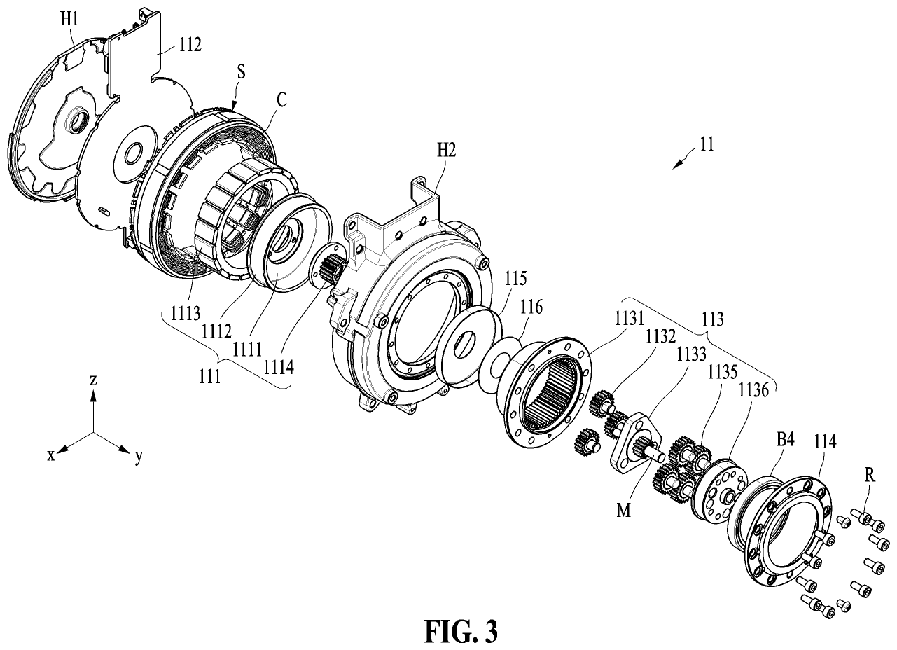

FIG. 3 is an exploded perspective view of an actuator according to an embodiment of the disclosure.

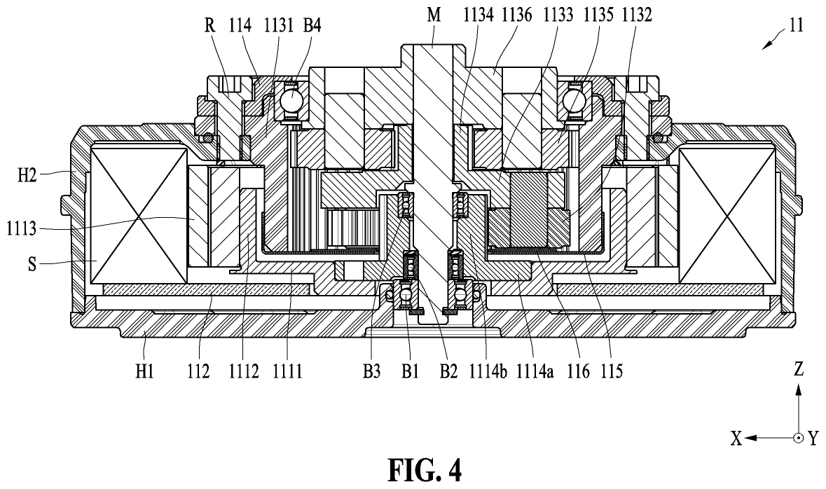

FIG. 4 is a cross-sectional view of an actuator according to an embodiment of the disclosure.

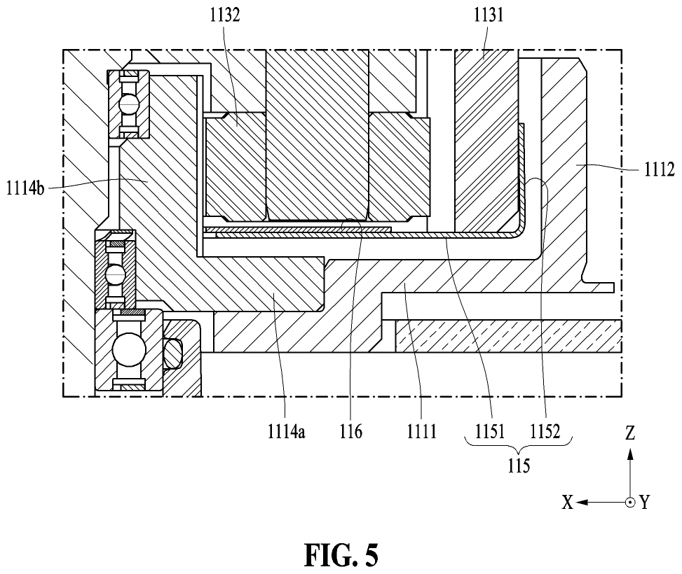

FIG. 5 is a partially enlarged view of an actuator according to an embodiment of the disclosure.

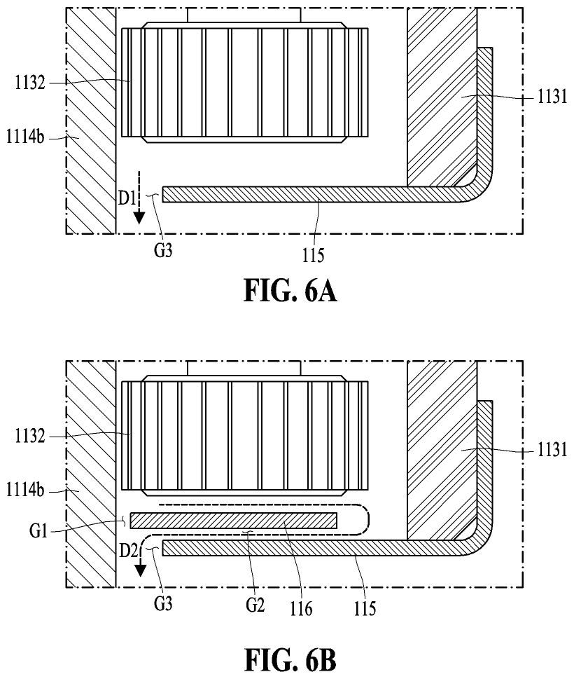

FIGS. 6A and 6B are cross-sectional views schematically illustrating a path through which a lubricant leaks from an input terminal of a reducer according to various embodiments of the disclosure.

Referring to FIGS. 3, 4, 5, 6A, and 6B, the actuator 11, according to an embodiment of the disclosure, may include a housing H, a stator S, a rotor 111, a substrate 112, a reducer 113, a supporter 114, an output terminal bearing B4, an outer washer 115, and an inner washer 116.

In an embodiment of the disclosure, the housing H may support the stator S of the actuator 11. The rotor 111 may be rotatably provided inside the housing H. The housing H may fix the stator S of the actuator 11. The housing H may include a lower cover H1 and an upper cover H2. The lower cover H1 may face the body of the user. The lower cover H1 may support the lower side of the rotor 111. The upper cover H2 may cover the side and the upper side of the stator S. The stator S may be restricted from moving up and down and left and right by the lower cover H1 and the upper cover H2. In other words, the stator S may be fixed between the lower cover H1 and the upper cover H2 without shaking.

In an embodiment of the disclosure, the upper cover H2 may be connected to the lower cover H1 by a cover fixing screw. The cover fixing screw may be provided in plurality along the circumference of the upper cover H2.

In an embodiment of the disclosure, the stator S may be fixed to the housing H. The stator S may generate a magnetic field to rotate the rotor 111. A coil C, through which a current may flow, may be connected to the stator S. The stator S may have, for example, a ring shape with a hole formed in a central portion. For example, the stator S may be donut-shaped. It should be noted in advance that the shape of the stator S is not limited thereto.

In an embodiment of the disclosure, the rotor 111 may rotate relative to the stator S. For example, the rotor 111 may be surrounded by the stator S. For example, the rotor 111 may be cup-shaped. The stator S and the rotor 111 may also be collectively referred to as a motor. The rotor 111 may include a main plate 1111, a vertical extension 1112, a permanent magnet 1113, and a first sun gear 1114.

In an embodiment of the disclosure, the main plate 1111 of the rotor 111 may be a plate parallel to a plane perpendicular to a central axis of the stator S. The vertical extension 1112 of the rotor 111 may be a portion extending vertically in one direction from an edge of the main plate 1111. The main plate 1111 and the vertical extension 1112 of the rotor 111 may form a cup shape together. The reducer 113 may be inserted into a space formed by the main plate 1111 and the vertical extension 1112.

In an embodiment of the disclosure, the permanent magnet 1113 of the rotor 111 may be provided in plurality along an outer circumferential surface of the vertical extension 1112 of the rotor 111. For example, the permanent magnet 1113 may be curved to have the same curvature as that of the vertical extension 1112, and the plurality of permanent magnets 1113 may be spaced apart from each other at regular intervals. The permanent magnets 1113 may interact with the magnetic field generated by the stator S. For example, when the permanent magnets 1113 of the rotor 111 interact with the magnetic field generated in the stator S, the rotor 111 may rotate in one direction.

In an embodiment of the disclosure, the first sun gear 1114 of the rotor 111 may be provided at the center of the main plate 1111. The first sun gear 1114 may rotate integrally with the main plate 1111. The first sun gear 1114 may be an output terminal of the motor. The output terminal of the motor may be connected to an input terminal of the reducer 113. For example, the first sun gear 1114 may be connected to the input terminal of the reducer 113. The first sun gear 1114 may include a gear base 1114a and a gear body 1114b.

In an embodiment of the disclosure, the gear base 1114a may be fixed to the main plate 1111 of the rotor 111 and may rotate integrally with the main plate 1111. The gear body 1114b may extend from the center of the gear base 1114a and may be connected to the reducer 113. As will be described later, the gear body 1114b may engage with a first planetary gear 1132 of the reducer 113.

In an embodiment of the disclosure, a plurality of central axis bearings B1, B2, and B3 may be provided along the center of the first sun gear 1114 to support a main shaft M that rotates integrally with the reducer 113.

In an embodiment of the disclosure, the stator S may be electrically connected to a controller (not shown) through the substrate 112. The substrate 112 may be, for example, a printed circuit board. The substrate 112 may control the magnetic field generated by the stator S. The substrate 112 may be directly connected to the coil C disposed inside the stator S, and may control a current flowing through the coil C by receiving a signal from the controller. The controller (not shown) may be provided, for example, on the waist belt. The controller (not shown) may control a rotational speed of the rotor 111 by adjusting the strength of the magnetic field generated from the stator S.

In an embodiment of the disclosure, the reducer 113 may be inserted into the inside of the rotor 111, may have the input terminal connected to the rotor 111, and may accommodate a lubricant. The lubricant may reduce friction between gears inside the reducer 113. For example, the reducer 113 may be inserted into a space surrounded by the vertical extension 1112 of the rotor 111. The first sun gear 1114, which is the output terminal of the motor, may be connected to the input terminal of the reducer 113. Hereinafter, a reduction mechanism of the reducer 113 will be described in detail, and then the outer washer 115 and the inner washer 116 will be described.

In an embodiment of the disclosure, the reducer 113 may include a ring gear 1131, a first carrier 1133, a second sun gear 1134, a plurality of second planetary gears 1135, and a second carrier 1136.

In an embodiment of the disclosure, the ring gear 1131 may be fixed to the housing H, and may surround the first sun gear 1114. A plurality of first planetary gears 1132 may be connected to the first sun gear 1114. The second carrier 1136 may be connected to the driving frame. In other words, the second carrier 1136 may be the output terminal of the reducer 113.

In an embodiment of the disclosure, the plurality of first planetary gears 1132 may be disposed between the first sun gear 1114 and the ring gear 1131. The first planetary gears 1132 may be, for example, spaced apart from each other at regular intervals along the circumference of the first sun gear 1114. The first planetary gear 1132 may have a gear shape that engages with the first sun gear 1114. One side of the first planetary gear 1132 may come into contact with the first sun gear 1114, and the other side thereof may come into contact with the ring gear 1131. When the first planetary gear 1132 rotates, the plurality of first planetary gears may rotate along the circumference of the first sun gear 1114.

In an embodiment of the disclosure, the first carrier 1133 may be connected to a central axis of the plurality of first planetary gears 1132. When the central axes of the plurality of first planetary gears 1132 revolve about the first sun gear 1114, the first carrier 1133 may rotate about the first sun gear 1114 at a rotational angular velocity equal to a revolution angular velocity of the central axes of the plurality of first planetary gears 1132. Since the central axis of each of the plurality of first planetary gears 1132 is coupled by the first carrier 1133, the central axis of each of the plurality of first planetary gears 1132 may revolve at the same revolution angular velocity. The rotational speed of the first carrier 1133 may be reduced compared to the rotational speed of the first sun gear 1114. In other words, a torque output from the first carrier 1133 may be greater than a torque transferred by the first sun gear 1114 to the first planetary gear 1132.

In an embodiment of the disclosure, the second sun gear 1134 may be formed at the center of the first carrier 1133. The second sun gear 1134 and the first carrier 1133 may be, for example, integrally formed as shown in FIG. 3. The second sun gear 1134 may be formed on the opposite side of the plurality of first planetary gears 1132. The second sun gear 1134 may rotate at the same angular velocity as that of the first carrier 1133.

In an embodiment of the disclosure, the plurality of second planetary gears 1135 may be disposed between the second sun gear 1134 and the ring gear 1131. The second planetary gears 1135 may be, for example, spaced apart from each other at regular intervals along the circumference of the second sun gear. The second planetary gears 1135 may have a gear shape that engages with the second sun gear 1134. One side of the second planetary gear 1135 may come into contact with the second sun gear 1134, and the other side thereof may come into contact with the ring gear 1131. When the second sun gear 1134 rotates, the plurality of second planetary gears 1135 may revolve along the circumference of the second sun gear 1134.

In an embodiment of the disclosure, the second carrier 1136 may be connected to the central axis of the plurality of second planetary gears 1135. When the central axes of the plurality of second planetary gears 1135 revolve about the second sun gear 1134, the second carrier 1136 may rotate about the second sun gear 1134 at a rotational angular velocity equal to a revolution angular velocity of the central axes of the plurality of second planetary gears. Since the central axis of each of the plurality of second planetary gears 1135 is coupled by the second carrier 1136, the central axis of each of the plurality of second planetary gears 1135 may revolve at the same revolution angular velocity. The rotational speed of the second carrier 1136 may be reduced compared to the rotational speed of the first carrier 1133. In other words, a torque output from the second carrier 1136 may be greater than the torque output from the first carrier 1133. The second carrier 1136 may be the output terminal of the reducer 113.

FIG. 3 illustrates that a reducer includes two planetary gear sets. It is to be noted that the structure of the reducer 113 is not limited thereto. For example, the reducer 113 may include a single planetary gear set.

Referring to FIG. 3, in an embodiment of the disclosure, the supporter 114 may be detachably connected to the housing H, and may support the reducer 113. The reducer 113 may be inserted into the housing H while being connected to the supporter 114. For example, the supporter 114, the ring gear 1131, and the upper cover H2 of the housing H may be screwed through a plurality of screws R. The output terminal bearing B4 may be disposed between the supporter 114 and the second carrier 1136. An upper surface of the output terminal bearing B4 may be supported by the supporter 114, and a lower surface thereof may be supported by the ring gear 1131. The second carrier 1136 may rotate about the supporter 114 through the output terminal bearing B4.

In an embodiment of the disclosure, the output terminal bearing B4 may be a rolling contact bearing or a contact seal bearing. Here, the contact seal bearing may be a bearing including a contact seal that shields a space between an outer ring and an inner ring of the rolling contact bearing from the outside, such as a light contact, light contact, under seal (LLU) bearing and a rubber seal (RS) bearing. The contact seal bearing may have a leak-proof function. When the contact seal bearing is used as the output terminal bearing B4, the amount of the lubricant leaking from the output terminal of the reducer may be reduced compared to the case where the rolling contact bearing is used.

In an embodiment of the disclosure, the outer washer 115 and inner washer 116 may prevent the lubricant accommodated inside the reducer 113 from leaking from the input terminal of the reducer 113. The outer washer 115 may be attached to the reducer 113, and may guide the movement of the lubricant discharged from the reducer 113. The lubricant discharged from the reducer 113 may move along a surface of the outer washer 115. The inner washer 116 may be disposed between the outer washer 115 and the reducer 113. The outer washer 115 and the inner washer 116 may form a maze structure to prevent the lubricant from leaking to a space between the ring gear 1131 and the first sun gear 1114. Hereinafter, the maze structure will be described in detail.

Referring to FIG. 6A, when the inner washer 116 does not exist, the lubricant discharged from the first planetary gear 1132 may move along a path D1 passing through a gap G3 between the gear body 1114b and the outer washer 115 and leak out of the reducer 113.

Referring to FIG. 6B, when the inner washer 116 is disposed on the outer washer 115, a gap G1 between the inner washer 116 and the gear body 1114b may be smaller than the gap G3 between the outer washer 115 and the gear body 1114b, but may not be large enough for the lubricant to pass through. In this structure, the lubricant discharged from the first planetary gear 1132 may not pass through the gap G1 between the inner washer 116 and the gear body 1114b, and may move in a direction toward the ring gear 1131 along a surface of the inner washer 116. The lubricant discharged from the first planetary gear 1132 needs to move along a path D2 so as to leak out of the reducer 113.

Meanwhile, since the inner washer 116 is supported by the outer washer 115, a gap G2 between the inner washer 116 and the outer washer 115 may not be large enough for the lubricant to pass through. Even when the lubricant enters the gap G2 between the inner washer 116 and the outer washer 115, the reducer 113 rotates and a centrifugal force is generated, and thus the lubricant may not move toward the gap G3 between the outer washer 115 and the gear body 1114b and may move in the opposite direction toward the ring gear 1131. For these reasons, the lubricant may move along the path D2 and may not leak out of the reducer 113. The structure of the outer washer 115 and the inner washer 116 forming the path D2 may be referred to as a maze structure. The outer washer 115 may include an outer base 1151 and an outer body 1152.

In an embodiment of the disclosure, the outer base 1151 may be attached to a support surface of the reducer 113. Here, the support surface of the reducer 113 is a surface of the reducer 113 facing the main plate 1111 of the rotor 111, which may correspond to a bottom surface of the ring gear 1131. The outer base 1151 may be disposed between the inner washer 116 and the main plate 1111. The outer base 1151 may have a ring shape with the center penetrated by the gear body 1114b. There may be a gap between the outer base 1151 and the gear body 1114b of the first sun gear 1114 so as not to interfere with the rotation of the first sun gear 1114.

In an embodiment of the disclosure, the outer body 1152 may surround the outer circumferential surface of the reducer 113. Here, the outer circumferential surface of the reducer 113 may correspond to a side surface of the ring gear 1131. The outer body 1152 may be a portion extending from the circumference of the outer base 1151 in a longitudinal direction of the ring gear 1131. The outer body 1152 may prevent the lubricant from leaking to a gap between the support surface of the reducer 113 and the outer base 1151.

In an embodiment of the disclosure, the inner washer 116 may be disposed on the outer base 1151. The inner washer 116 may have a ring shape with the center penetrated by the gear body 1114b. The inner washer 116 may not be fixed to other components and may be restricted from moving up and down by the outer base 1151 and the first planetary gear 1132 so as not to be separated from the gear body 1114b. The inner washer 116 may have an upper surface facing the first planetary gear 1132 and a lower surface facing the outer washer 115. The lubricant may pass through the upper surface of the inner washer 116 before reaching the outer washer 115. The upper surface of the inner washer 116 may guide the movement of the lubricant discharged from the first planetary gear 1132. The lubricant discharged from the reducer 113 may move along the upper surface of the inner washer 116 toward the ring gear 1131 and reach the outer washer 115. As described above, the lubricant that reaches the outer washer 115 may not leak from the input terminal of the reducer 113.

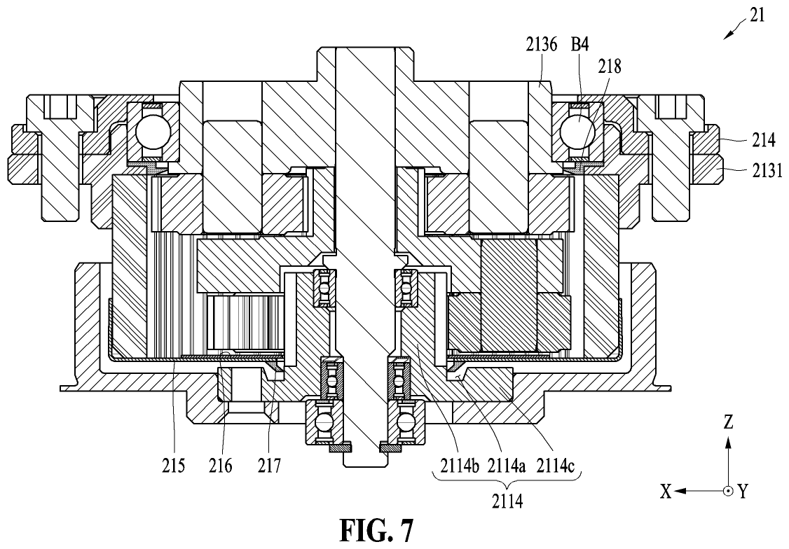

FIG. 7 is a cross-sectional view of an actuator according to an embodiment of the disclosure.

Referring to FIG. 7, an actuator 21, according to an embodiment of the disclosure, may further include an input terminal sealing member 217 to reduce the amount of lubricant leaking from the input terminal of the reducer.

In an embodiment of the disclosure, the input terminal sealing member 217 may be connected to the outer washer 215 and may block the lubricant from moving into a space between the outer washer 215 and the first sun gear 2114. For example, the input terminal sealing member 217 may prevent the lubricant that has passed through a space between the inner washer 216 and the gear body 2114b of the first sun gear 2114 from flowing into a space between the outer washer 215 and the gear body 2114b and leaking out of the reducer. For example, the input terminal sealing member 217 may prevent the lubricant that flows toward the center of the reducer through a space between a lower surface of the inner washer 216 and the outer washer 215 from flowing into the space between the outer washer 215 and the gear body 2114b and leaking out of the reducer.

In one embodiment of the disclosure, one side of the input terminal sealing member 217 may be fixed to the outer washer 215, and the other side thereof may be maintained in contact with the first sun gear 2114. In order not to interfere with the rotation of the first sun gear 2114, the input terminal sealing member 217 may be formed of a flexible material, such as rubber.

In an embodiment of the disclosure, the input terminal sealing member 217 may be accommodated in a gear groove 2114c recessed in a gear base 2114a. In this structure, even if the input terminal sealing member 217 is additionally disposed on the actuator 21, the overall width of the actuator 21 may not change.

In an embodiment of the disclosure, there is a risk that the lubricant may leak from the output terminal of the reducer through a space between the supporter 214 and a second carrier 2136. To prevent the lubricant from leaking from the output terminal of the reducer, the actuator 21 may further include an output terminal sealing member 218.

In an embodiment of the disclosure, a lower surface of the output terminal sealing member 218 may be supported by a ring gear 2131, and an upper surface thereof may be supported by the output terminal bearing B4. The vertical movement of the output terminal sealing member 218 may be restricted by the output terminal bearing B4 and ring gear 2131, respectively. One end portion of the output terminal sealing member 218 may extend toward the second carrier 2136. In this structure, the output terminal sealing member 218 may block the lubricant inside the reducer from passing through a space between the ring gear 2131 and the second carrier 2136. The amount of lubricant leaking from the output terminal of the reducer may be reduced.

In an embodiment of the disclosure, when the contact seal bearing is used as the output terminal bearing B4 and the output terminal sealing member 218 is disposed, the amount of lubricant leaking from the output terminal may be further reduced.

In an embodiment of the disclosure, in a state where the output terminal sealing member 218 is supported by the ring gear 2131 and the output terminal bearing B4, the one end portion of the output terminal sealing member 218 may be maintained in contact with the second carrier 2136. In order not to interfere with the rotation of the second carrier 2136, the output terminal sealing member 218 may be formed of a flexible material, such as rubber.

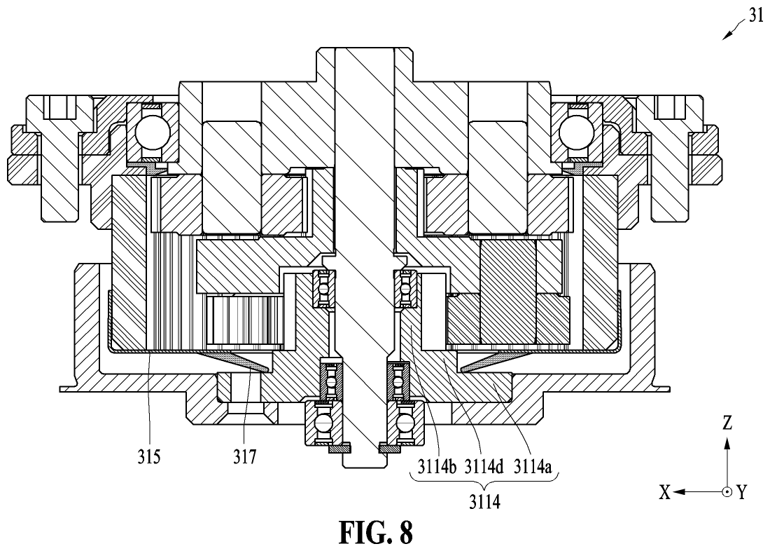

FIG. 8 is a cross-sectional view of an actuator according to an embodiment of the disclosure.

Referring to FIG. 8, an actuator 31, according to an embodiment of the disclosure, may include an outer washer 315 and an input terminal sealing member 317, and may prevent the lubricant inside the reducer from leaking from the input terminal. In other words, the actuator 31 may not include an inner washer.

In cases like the above, a first sun gear 3114 may have a step structure, thereby reducing a gap between the outer washer 315 and a gear body 3114b of the first sun gear 3114. The amount of lubricant passing through between the outer washer 315 and the first sun gear 3114 may be reduced. For example, the first sun gear 3114 may include a horizontal end 3114d formed between a gear base 3114a and the gear body 3114b. The input terminal sealing member 317 may be maintained in contact with the gear base 3114a of the first sun gear 3114, while preventing the leakage of the lubricant that has passed through a space between the first sun gear 3114 and the outer washer 315.

A motion assistive device, according to an embodiment of the disclosure, may include a waist frame worn on a waist of a user, a waist belt connected to the waist frame and covers a portion of the waist of the user, a force transfer frame that covers a portion of a thigh of the user, a thigh belt connected to the force transfer frame and surrounds the thigh of the user, an actuator connected to the waist frame and generates power, and a driving frame connected to the actuator and transfers the power to the force transfer frame, and the actuator may include a housing, a stator fixed to the housing, a rotor positioned inside the stator and rotatable relative to the stator, a reducer inserted inside the rotor, having an input terminal connected to the rotor, and accommodates a lubricant, an outer washer attached to the reducer and guides movement of the lubricant discharged from the reducer, and an inner washer disposed between the outer washer and the reducer.

According to an embodiment of the disclosure, the lubricant discharged from the reducer may pass through the inner washer before reaching the outer washer.

According to an embodiment of the disclosure, the inner washer may include an upper surface facing the reducer, and a lower surface facing the outer washer.

According to an embodiment of the disclosure, the housing may include a lower cover that rotatably supports the rotor, and an upper cover that extends from the lower cover and covers side and upper surfaces of the stator.

According to an embodiment of the disclosure, the rotor may include a main plate provided parallel to the lower cover, a vertical extension that extends from the main plate and is positioned between the stator and the reducer, and a first sun gear that rotates about a rotation axis of the main plate.

According to an embodiment of the disclosure, the reducer may include a support surface facing the main plate of the rotor, and an outer circumferential surface facing the vertical extension.

According to an embodiment of the disclosure, the outer washer may include an outer base attached to the support surface of the reducer, and an outer body surrounding the outer circumferential surface of the reducer.

According to an embodiment of the disclosure, the outer base may be disposed between the inner washer and the main plate.

According to an embodiment of the disclosure, the reducer may include a ring gear fixed to the housing and surrounds the first sun gear, a plurality of first planetary gears disposed between the first sun gear and the ring gear and engages with the first sun gear and the ring gear, and a first carrier connected to a central axis of each of the plurality of first planetary gears.

According to an embodiment of the disclosure, the first sun gear may include a gear base fixed to the main plate, and a gear body that rotates together with the gear base and rotates the first planetary gear.

According to an embodiment of the disclosure, the actuator may further include an input terminal sealing member connected to the outer washer, and blocks the lubricant from moving into a space between the outer washer and the first sun gear.

According to an embodiment of the disclosure, the first sun gear may further include a gear groove recessed in the gear base and accommodates the input terminal sealing member.

According to an embodiment of the disclosure, the reducer may further include a second sun gear connected to the first carrier and rotates together with the first carrier, a plurality of second planetary gears disposed between the second sun gear and the ring gear and engages with the second sun gear and the ring gear, and a second carrier connected to a central axis of each of the plurality of second planetary gears and connected to the driving frame.

According to an embodiment of the disclosure, the actuator may include a supporter that supports the reducer and is detachably connected to the housing, and an output terminal bearing disposed between the supporter and the second carrier.

According to an embodiment of the disclosure, the actuator may further include an output terminal sealing member supported by the ring gear and blocks the lubricant from moving into a space between the ring gear and the second carrier.

An actuator, according to an embodiment of the disclosure, may include a housing, a stator fixed to the housing, a rotor positioned inside the stator and rotatable relative to the stator and includes a first sun gear, a ring gear inserted inside the rotor, accommodates a lubricant, is fixed to the housing, and surrounds the first sun gear, a plurality of first planetary gears disposed between the first sun gear and the ring gear and engages with the first sun gear and the ring gear, a reducer including a first carrier connected to a central axis of each of the plurality of first planetary gears, an outer washer attached to the ring gear and guides movement of the lubricant discharged from the reducer, and an input terminal sealing member connected to the outer washer, and blocks the lubricant from moving into a space between the outer washer and the first sun gear.

According to an embodiment of the disclosure, the reducer may further include a second sun gear connected to the first carrier and rotates together with the first carrier, a plurality of second planetary gears disposed between the second sun gear and the ring gear and engages with the second sun gear and the ring gear, and a second carrier connected to a central axis of each of the plurality of second planetary gears.

According to an embodiment of the disclosure, the actuator may include a supporter that supports the reducer and is detachably connected to the housing, and an output terminal bearing disposed between the supporter and the second carrier.

According to an embodiment of the disclosure, the actuator may further include an output terminal sealing member supported by the ring gear and blocks the lubricant from moving into a space between the ring gear and the second carrier.

A motion assistive device, according to an embodiment of the disclosure, may include a waist frame worn on a waist of a user, a waist belt connected to the waist frame and covers a portion of the waist of the user, a force transfer frame that covers a portion of a thigh of the user, a thigh belt connected to the force transfer frame and surrounds the thigh of the user, an actuator connected to the waist frame and generates power, and a driving frame connected to the actuator and transfers the power to the force transfer frame, and the actuator may include a housing, a stator fixed to the housing, a rotor positioned inside the stator and rotatable relative to the stator, a reducer inserted inside the rotor, having an input terminal connected to the rotor, and accommodates a lubricant, an outer washer attached to the reducer and guides movement of the lubricant discharged from the reducer, and a supporter that supports the reducer and is detachably connected to the housing, an input terminal sealing member connected to the outer washer, and blocks the lubricant from moving into a space between the outer washer and the reducer, and an output terminal bearing supported by the supporter and the reducer.

In addition, at least one component or feature of the embodiments described above may be coupled to an electronic device unless this is technically and clearly infeasible.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A motion assistive device comprising:
a waist frame worn on a user's waist;
a waist belt connected to the waist frame and covers a portion of the user's waist;
a force transfer frame that covers a portion of a user's thigh;
a thigh belt connected to the force transfer frame and surrounds the user's thigh;
an actuator connected to the waist frame and generates power; and
a driving frame connected to the actuator and transfers the power to the force transfer frame,
wherein the actuator comprises:
a housing,
a stator fixed to the housing,
a rotor positioned inside the stator and rotatable relative to the stator,
a reducer inserted inside the rotor, having an input terminal connected to the rotor, and accommodates a lubricant,
an outer washer attached to the reducer and guides movement of the lubricant discharged from the reducer, and
an inner washer disposed between the outer washer and the reducer.

2. The motion assistive device of claim 1, wherein the lubricant discharged from the reducer passes through the inner washer before reaching the outer washer.

3. The motion assistive device of claim 2, wherein the inner washer comprises an upper surface facing the reducer, and a lower surface facing the outer washer.

4. The motion assistive device of claim 1, wherein the housing comprises:
a lower cover that rotatably supports the rotor; and
an upper cover that extends from the lower cover and covers side and upper surfaces of the stator.

5. The motion assistive device of claim 4, wherein the rotor comprises:
a main plate provided parallel to the lower cover;
a vertical extension that extends from the main plate and is positioned between the stator and the reducer; and
a first sun gear that rotates about a rotation axis of the main plate.

6. The motion assistive device of claim 5, wherein the reducer comprises a support surface facing the main plate of the rotor, and an outer circumferential surface facing the vertical extension.

7. The motion assistive device of claim 6, wherein the outer washer comprises:
an outer base attached to the support surface of the reducer; and
an outer body surrounding the outer circumferential surface of the reducer.

8. The motion assistive device of claim 7, wherein the outer base is disposed between the inner washer and the main plate.

9. The motion assistive device of claim 5, wherein the reducer comprises:
a ring gear fixed to the housing and surrounds the first sun gear;
a plurality of first planetary gears disposed between the first sun gear and the ring gear and engages with the first sun gear and the ring gear; and
a first carrier connected to a central axis of each of the plurality of first planetary gears.

10. The motion assistive device of claim 9, wherein the first sun gear comprises:
a gear base fixed to the main plate; and
a gear body that rotates together with the gear base and rotates the first planetary gears.

11. The motion assistive device of claim 10, wherein the actuator further comprises an input terminal sealing member connected to the outer washer, and blocks the lubricant from moving into a space between the outer washer and the first sun gear.

12. The motion assistive device of claim 11, wherein the first sun gear further comprises a gear groove recessed in the gear base and accommodates the input terminal sealing member.

13. The motion assistive device of claim 9, wherein the reducer further comprises:
a second sun gear connected to the first carrier and rotates together with the first carrier;
a plurality of second planetary gears disposed between the second sun gear and the ring gear and engages with the second sun gear and the ring gear; and
a second carrier connected to a central axis of each of the plurality of second planetary gears and connected to the driving frame.

14. The motion assistive device of claim 13, wherein the actuator comprises:
a supporter that supports the reducer and is detachably connected to the housing; and
an output terminal bearing disposed between the supporter and the second carrier.

15. The motion assistive device of claim 14, wherein the actuator further comprises an output terminal sealing member supported by the ring gear and blocks the lubricant from moving into a space between the ring gear and the second carrier.

16. A motion assistive device comprising:
a waist frame worn on a user's waist;
a waist belt connected to the waist frame and covers a portion of the user's waist;
a force transfer frame that covers a portion of a user's thigh;
a thigh belt connected to the force transfer frame and surrounds the user's thigh;
an actuator connected to the waist frame and generates power; and
a driving frame connected to the actuator and transfers the power to the force transfer frame,
wherein the actuator comprises:
a housing,
a stator fixed to the housing,
a rotor positioned inside the stator and rotatable relative to the stator,
a reducer inserted inside the rotor, having an input terminal connected to the rotor, and accommodates a lubricant,
an outer washer attached to the reducer and guides movement of the lubricant discharged from the reducer, and a supporter that supports the reducer and is detachably connected to the housing,
an input terminal sealing member connected to the outer washer, and blocks the lubricant from moving into a space between the outer washer and the reducer, and
an output terminal bearing supported by the supporter and the reducer.
